(19) United States
(12) Patent Application Publication
(10) Pub. No.: US 2025/0042581 A1
(43) Pub. Date: Feb. 6, 2025

(54) LANDING AND TAKEOFF RESPONSE SYSTEM AND METHOD FOR UNMANNED AERIAL VEHICLE

(71) Applicant: Qisda Corporation, Taoyuan City (TW)

(72) Inventors: Chih-Ming CHANG, Taoyuan City (TW); Po-Fu WU, Taoyuan City (TW)

(73) Assignee: Qisda Corporation, Taoyuan City (TW)

(21) Appl. No.: 18/638,748

(22) Filed: Apr. 18, 2024

(30) Foreign Application Priority Data
Aug. 2, 2023 (CN) 202310966665.7

(51) Int. Cl. B64U 70/90

(52) U.S. Cl. CPC B64U 70/90

(57) ABSTRACT

A landing/takeoff response system and method for an UAV, including a fuselage having a housing and a flight power module connected to the fuselage, are provided. The system includes a first sensor for detecting a first sensing information, at least one second sensor for detecting a second sensing information, and a processing unit coupled to the first sensor and the second sensor. The first sensor is disposed on a bottom portion of the housing at a position below a center of gravity of the UAV. The second sensor is disposed on a side portion of the housing adjacent to the bottom portion. The processing unit is configured to: determine whether the first sensing information satisfies a first contact condition to determine a landing/takeoff operation of the UAV; and determine whether the second sensing information satisfies a second contact condition to determine an on/off status of the flight power module.

This application claims the benefit of People's Republic of China patent application Serial No. 202310966665.7, filed Aug. 2, 2023, the invention of which are incorporated by reference herein in its entirety.

### TECHNICAL FIELD

The present invention relates in general to a landing and takeoff response system and method, and more particularly to a landing and takeoff response system and method for an unmanned aerial vehicle (UAV).

### BACKGROUND

Unmanned Aerial Vehicle (UAV) refers to a flight device without a pilot on board. The UAV may be maneuvered by remote control in manual control mode, or by control system in automatic flight mode, and land in different environments to perform a variety of tasks. The UAV may takeoff from the ground or by hand-thrown. For the hand-thrown UAV, the landing and takeoff operation of the UAV still pose a certain degree of danger to the hand-held operator of the UAV.

### SUMMARY

The present invention is directed to a landing and takeoff response system and method for an UAV, which determines a response action for landing and takeoff of the UAV by determining whether the sensing information provided by a first sensor and at least one second sensor satisfies a contact condition, in order to reduce the probability of an accident occurring during the operation of the holder.

According to one aspect of the present invention, a landing and takeoff response system for an UAV is provided. The UAV includes a fuselage having a housing and a flight power module connected to the fuselage. The landing and takeoff response system includes a first sensor, at least one second sensor and a processing unit. The first sensor is disposed on a bottom portion of the housing at a position below a center of gravity of the UAV, and configured to detect a first sensing information. The second sensor is disposed on a side portion of the housing, the side portion adjacent to the bottom portion, and configured to detect a second sensing information. The processing unit is coupled to the first sensor and the second sensor, and configured to: determine whether the first sensing information satisfies a first contact condition, so as to determine a landing and takeoff operation of the UAV; and determine whether the second sensing information satisfies a second contact condition, so as to determine an on/off status of the flight power module.

According to another aspect of the present invention, a landing and takeoff response method for an UAV is provided. The UAV includes a fuselage having a housing and a flight power module connected to the fuselage. The landing and takeoff response method includes: detecting a first sensing information by a first sensor, and detecting a second sensing information by at least one second sensor. The first sensor is disposed on a bottom portion of the housing at a position below a center of gravity of the UAV. The second sensor is disposed on a side portion of the housing, and the side portion is adjacent to the bottom portion. Then, whether the first sensing information satisfies a first contact condition is determined, so as to determine a landing and takeoff operation of the UAV; and whether the second sensing information satisfies a second contact condition is determined, so as to determine an on/off status of the flight power module.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of an UAV according to one embodiment of the present invention.

FIG. 2 is a three-dimensional view of the UAV in a first viewpoint according to one embodiment of the present invention.

FIG. 3 is a three-dimensional view of the UAV in a second viewpoint according to one embodiment of the present invention.

### DETAILED DESCRIPTION

The landing and takeoff response system and method for an UAV may determine a response action for landing and takeoff of the UAV by determining whether the sensing information provided by a first sensor and at least one second sensor satisfies a contact condition, in order to reduce the probability of an accident occurring during the operation of the holder. Further, the landing and takeoff operation of the UAV may be determined by determining whether the first sensing information satisfies the first contact condition, and the on/off status of the flight power module may be determined by determining whether the second sensing information satisfies the second contact condition.

Embodiments of the present invention will be described in detail hereinafter, and illustrated with the accompanying drawings. In addition to these detailed descriptions, the present invention may be broadly implemented in other embodiments, and any substitutable, modified, equivalent variations of the embodiments are included within the scope of the present invention. The scope of the present is subject to the claims thereafter. In the description of the specification, many specific details and examples of embodiments are provided in order to provide the reader with a more complete understanding of the present invention; however, these specific details and examples of embodiments should not be considered as limitations of the present invention. In addition, well-known steps or elements are not described in detail to avoid unnecessary limitations of the present invention. In the drawings, identical or similar element numerals are used to represent identical or similar elements.

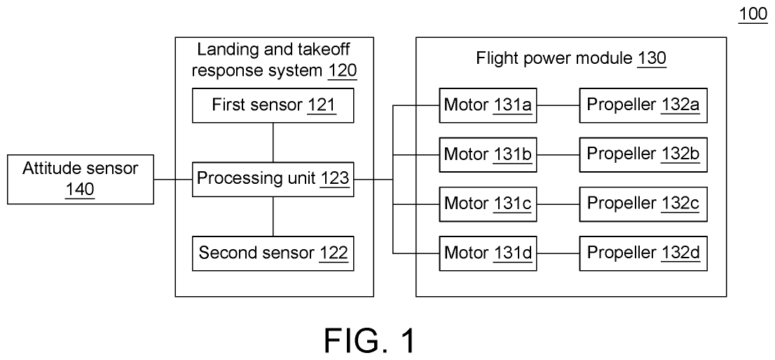

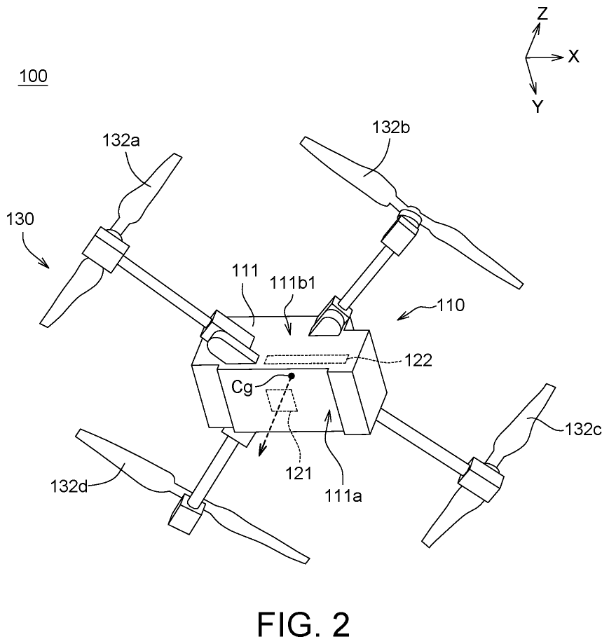

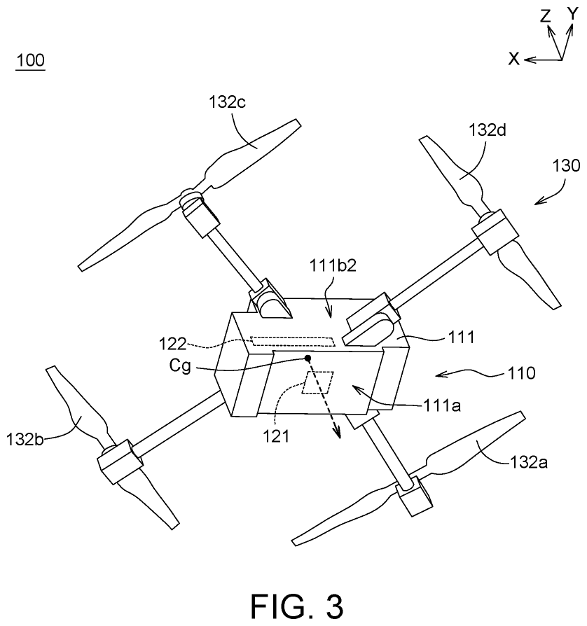

FIG. 1 is a block diagram of an UAV 100 according to one embodiment of the present invention; FIG. 2 is a three-dimensional view of the UAV 100 in a first viewpoint according to one embodiment of the present invention; FIG. 3 is a three-dimensional view of the UAV 100 in a second viewpoint according to one embodiment of the present invention.

Referring to FIGS. 1-3, the landing and takeoff response system 120 is installed and applied to the UAV 100, and the landing and takeoff response system 120 may detect whether the UAV 100 is currently being held by a holder, and then provide relevant response actions.

The UAV 100 may include a fuselage 110, a flight power module 130, and an attitude sensor 140. The fuselage 110 may have a housing 111. The flight power module 130 is connected to the fuselage 110 and may include at least one motor 131a, 131b, 131c, 131d and at least one propeller 132a, 132b, 132c, 132d. The motor 131a, 131b, 131c, 131d may be connected to corresponding propellers 132a, 132b, 132c, 132d, and may drive the propellers 132a, 132b, 132c, 132d to provide upward or downward thrust to the UAV 100. The attitude sensor 140 may be disposed within the fuselage 110, including but not limited to, a gravity sensor, gyroscope, accelerometer, electronic compass, etc., to detect the current attitude of the UAV 100.

The landing and takeoff response system 120 includes a first sensor 121, at least one second sensor 122, and a processing unit 123. The first sensor 121 is disposed on a bottom portion 111a of the housing 111 and is located below the center of gravity Cg of the UAV 100. That is, the gravitational force on the center of gravity Cg of the UAV 100 passes through the first sensor 121. In one embodiment, the housing 111 may include a battery pack, and the first sensor 121 may be disposed at a location of the bottom of the battery pack, which may be part of the bottom portion 111a of the housing 111. The second sensor 122 may be disposed on the side portions 111b1 and/or 111b2 of the housing 111. The side portions 111b1, 111b2 are disposed opposite to each other and are adjacent to the bottom portion 111a, respectively. In one embodiment, the number of second sensors 122 may be two, which are disposed on the two side portions 111b1, 111b2 of the housing 111; in another embodiment, the number of second sensor 122 may be one, which is disposed on one of the two side portions 111b1, 111b2 of the housing 111.

The first sensor 121 and the second sensors 122 may be one of a capacitance sensor, an image sensor, and a distance sensor, respectively. If the first sensor 121 and/or the second sensors 122 are capacitance sensors, the first sensor 121 and/or the second sensors 122 may be disposed on the inner side of the housing 111 and hidden inside the bottom portion 111a; if the first sensor 121 and/or the second sensors 122 are image sensors or distance sensors, the first sensor 121 and/or the second sensors 122 may be disposed on the outer side of the housing 111 and exposed outside the bottom portion 111a. Thus, the placements of the first sensor 121 and/or the second sensors 122 may be disposed on the inner surface or the outer surface of the bottom portion 111a depending on the type of sensor.

In addition, the first sensor 121 and the second sensors 122 may be disposed at a location that is easily grasped and reached by the holder with single hand. Further, the housing 111 may be provided with a long side and a short side. The long side is parallel to the X-axis and the short side is parallel to the Y-axis, and thus the housing 111 may have a relatively narrow shape so that the holder may naturally grasp the housing 111 with the palm of the single hand in a positive direction toward the Z-axis. When the holder grasps the housing 111 with hand, the palm of the hand corresponds to the position of the first sensor 121, and the thumb and the other four fingers correspond to the position of the second sensors 122 which are disposed on the two opposite sides respectively. In other words, the housing 111 is adapted to be grasped by a single hand, the first sensor 121 is adapted to detect whether there is contact with the palm of the hand and thereby detect the first sensing information, and the second sensor 122 is adapted to detect whether there is contact with the thumb or the other four fingers and thereby detect the second sensing information. In one embodiment, as shown in FIGS. 2 and 3, the second sensors 122 may have an elongated shape configured in the direction of the X-axis to accommodate different people with different hand sizes. Further, the bottom portion 111a and the two side portions 111b1, 111b2 may also be designed to accommodate different curvatures of the human hands in condition of hand open with palm up and grasping.

Referring to FIGS. 1-3, the processing unit 123 is coupled to the attitude sensor 140 and the motors 131a, 131b, 131c, 131d. In addition, the processing unit 123 is coupled to the first sensor 121 and the at least one second sensor 122, and receives the first sensing information and the second sensing information detected by the first sensor 121 and the second sensor 122. The processing unit 123 may determine whether the first sensing information satisfies a first contact condition to determine a landing and takeoff operation of the UAV 100, and determine whether the second sensing information satisfies a second contact condition to determine an on/off status of the flight power module 130.

In some embodiments, when the first sensor 121 and/or the second sensor 122 is a capacitance sensor, the first sensing information and/or the second sensing information includes a capacitance value. When a change in the capacitance is greater than a predetermined value, it may be determined that the first sensing information and/or the second sensing information satisfies the first contact condition and/or the second contact condition. In other embodiments, when the first sensor 121 and/or the second sensor 122 is an image sensor or a distance sensor, the first sensing information and/or the second sensing information includes a detected distance. When the detected distance is less than a predetermined value, it may be determined that the first sensing information and/or the second sensing information satisfies the first contact condition and/or the second contact condition.

Table 1 shows one embodiment of a hand-thrown UAV 100 during takeoff and landing.

TABLE 1

| HOLDING MODE | POSITION OF HAND | ACTION OF UAV |
|---|---|---|
| GRASPING | Palm touches the first | Landing and takeoff |
| | sensor, thumb and/or | operation is prohibited |
| | the other four fingers | (cannot fly vertically |
| | touch the second | upward or downward); |
| | sensor | flight power module is in |
| | | off status (the motor is |
| | | turned off and the |
| | | propeller cannot rotate) |
| HAND OPEN | Palm touches the first | Landing and takeoff |
| WITH PALM UP | sensor, thumb and the | operation is prohibited |
| | other four fingers do not | (cannot fly vertically |
| | touch the second | upward or downward); |
| | sensor | flight power module is in |
| | | on status (the motor can |
| | | be turned off and the |
| | | propeller can rotate) |
| HAND-THROWN | Palm, thumb and the | Landing and takeoff |
| LANDING/ | other four fingers do not | operation is permitted |
| TAKEOFF | touch the first sensor | (capable of flying |
| | and the second sensor | vertically upward or |
| | | downward); flight power |
| | | module is in on status |
| | | (the motor can be |
| | | turned off and the |
| | | propeller can rotate) |

When the holder grasps the housing 111 of the UAV 100 with a single hand, as in the GRASPING MODE of Table 1, the palm of the holder touches the first sensor 121 on the bottom portion 111a, and the thumb and/or the other four fingers touch the second sensor(s) 122 on the side portion 111b1 and/or 111b2. In this case, the processing unit 123 determines that the first sensor information detected by the first sensor 121 satisfies the first contact condition, and the second sensor information detected by the second sensor(s) 122 satisfies the second contact condition, and causes the motor 131a, 131b, 131c, 131d to turn off. In this case, the processing unit 123 determines that the first sensory information detected by the first sensor 121 satisfies the first contact condition and the second sensory information detected by the second sensor 122 satisfies the second contact condition. Thus, the processing unit 123 commands the motors 131a, 131b, 131c, 131d to be turned off, and accordingly, the propellers 132a, 132b, 132c, 132d cannot be rotated. In other words, when the processing unit 123 determines that the first sensing information and the second sensing information satisfy the first contact condition and the second contact condition, respectively, the flight power module 130 is in an off status, so as to prevent the propellers 132a, 132b, 132c, 132d of the UAV 100 from being activated and injuring the holder. At this time, the UAV 100 cannot fly vertically upward or downward, and it is prohibited to perform the landing and takeoff operation of the UAV 100.

When the holder holds the housing 111 of the UAV 100 by a single hand open with palm up, as in the HAND OPEN WITH PALM UP MODE of Table 1, the palm of the holder's hand touches the first sensor 121, and the thumb and the other four fingers do not touch the second sensor(s) 122. In this case, the processing unit 123 determines that the first sensor information detected by the first sensor 121 satisfies the first contact condition, but the second sensor information detected by the second sensor(s) 122 does not satisfy the second contact condition. Thus, the processing unit 123 commands the motor 131a, 131b, 131c, 131d to be turned on, and accordingly, the propellers 132a, 132b, 132c, 132d can rotate to provide a lift force which is less than a force sufficient for the UAV to take off vertically upward. The processing unit 123 may control the rotational speeds of the motors 131a, 131b, 131c, 131d based on the information from the attitude sensor 140, so that the lift force generated by the four propellers 132a, 132b, 132c, 132d of the UAV 100 is less than or equal to the downward force exerted on the UAV 100, and thus the UAV 100 cannot take off vertically upward. If the lift force generated by the propellers 132a, 132b, 132c, 132d is almost equal to the weight of the UAV 100, which means that the palm of the hand only slightly touches the bottom portion 111a of the housing 111 but provides almost no upward bearing force to the UAV 100, the UAV 100 may be maintained in a hovering mode. In other words, when the processing unit 123 determines that the first sensing information satisfies the first contact condition but the second sensing information does not satisfy the second contact condition, the flight power module 130 is in an on state and is capable of providing a hovering lift force sufficient for the UAV 100 to maintain in the hovering mode, i.e., the maximum lift force is the hovering lift force that maintains the UAV 100 in the hovering mode. At this time, the UAV 100 still cannot fly vertically upward or downward, and it is prohibited to perform the landing and takeoff operation of the UAV 100.

When the holder throws the UAV 100 upward, the palm of the hand detaches from the UAV 100 downward, or the UAV 100 lands from the air, as in the HAND-THROWN LANDING/TAKEOFF MODE in Table 1, the palm of the hand, the thumb, and the other four fingers of the holder do not touch the first sensor 121 and the second sensor(s) 122. In this case, the processor unit 123 determines that the first sensing information detected by the first sensor 121 does not satisfy the first contact condition, and the second sensing information detected by the second sensor(s) 122 does not satisfy the second contact condition. Thus, the processing unit 123 commands the motors 131a, 131b, 131c, 131d to be turned on, and accordingly, the propellers 132a, 132b, 132c, 132d can rotate and may be capable of providing an ascent/descent force required for a vertically upward or vertically downward flight of the UAV 100 within a predetermined altitude. When the UAV 100 flies within a predetermined altitude, the processing unit 123 may control the rotational speeds of the motors 131a, 131b, 131c, 131d based on the information from the attitude sensor 140, so that the four propellers 132a, 132b, 132c, 132d of the UAV 100 generate the ascent/descent force required for a vertically upward or vertically downward flight. In other words, when the processing unit 123 determines that both the first sensing information and the second sensing information do not satisfy the first contact condition and the second contact condition, the flight power module 130 is in an on status and is capable of providing an ascent/descent force required for a vertically upward or vertically downward flight of the UAV 100. At this time, the UAV 100 can fly vertically upward or downward, and it is permitted to perform the landing and takeoff operation of the UAV 100.

In the HAND-THROWN LANDING/TAKEOFF MODE as set out above, the UAV 100 may only move vertically upward or downward within the predetermined altitude. For example, if the processing unit 123 determines that both the first sensing information and the second sensing information do not satisfy the first contact condition and the second contact condition, within the predetermined altitude of, for example, 3 meters, the UAV 100 may be restricted to fly vertically upward or downward; once after the altitude is over 3 meters, the UAV 100 is allowed to fly leftward or rightward, so as to reduce the risk of injuring or colliding with the holder. Further, the processing unit 123 may receive information transmitted from the remote control operated by the holder, and use the information to determine whether the UAV 100 only flies vertically upward or downward. For example, if the holder turns on a switch of the remote control that permits only a vertical upward or downward movement, the UAV 100 may only fly vertically upward or downward, or if the switch is turned off, the UAV 100 is not restricted to only fly vertically upward or downward.

According to the corresponding actions during takeoff and landing of the UAV 100 as set out above, the processing unit 123 may determine the landing and takeoff operation of the UAV 100 by determining whether the first sensing information satisfies the first contact condition. For example, when the palm of the hand touches the first sensor 121, it means that the holder holds the UAV 100 in a GRASPING MODE or a HAND OPEN WITH PALM UP MODE, and the processing unit 123 prohibits the landing and takeoff operation of the UAV 100, so that the UAV 100 cannot fly vertically upward or downward. When the palm of the hand does not touch the first sensor 121, it means that the holder throws the UAV 100 in a HAND-THROWN LANDING/TAKEOFF MODE, and the processing unit 123 allows performing the landing and takeoff operation of the UAV 100, so that the UAV 100 can fly vertically upward or downward. In addition, the processing unit 123 may determine the on/off status of the flight power module 130 by determining whether the second sensing information satisfies the second contact condition. For example, when the thumb and/or the other four fingers touch the second sensor(s) 122, it means that the holder holds the UAV 100 in a GRASPING MODE, and the processing unit 123 commands the flight power module 130 to be in an off status, at which time the motors 131a-131d are turned off, and the propellers 132a-132d cannot rotate to avoid injuring the holder. When neither the thumb nor the other four fingers touch the second sensor(s) 122, it means that the holder holds the UAV 100 in a HAND OPEN WITH PALM UP MODE, or throws the UAV 100 in a HAND-THROWN LANDING/TAKEOFF MODE, the processing unit 123 commands the flight power module 130 to be in an on status, at which time the motors 131a-131d are turned on and the propellers 132a-132d can rotate.

Through the response action for landing and takeoff of the UAV 100 provided herein, in the manual control mode of the UAV 100, when the operator with a remote control and the holder of the UAV 100 are different persons, it is possible to avoid the danger that may arise from the mismatch of the movements of the operator and the holder of the UAV 100. In the automatic flight mode of the UAV 100, the blind spot of the automatic flight program may be avoided to ensure the safety of the holder.

It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. A landing and takeoff response system for an unmanned aerial vehicle (UAV), the UAV comprising a fuselage having a housing and a flight power module connected to the fuselage, the landing and takeoff response system comprising:
a first sensor disposed on a bottom portion of the housing at a position below a center of gravity of the UAV, the first sensor configured to detect a first sensing information;
at least one second sensor disposed on a side portion of the housing, the side portion adjacent to the bottom portion, the least one second sensor configured to detect a second sensing information; and
a processing unit coupled to the first sensor and the at least one second sensor, the processing unit configured to:
determine whether the first sensing information satisfies a first contact condition, so as to determine a landing and takeoff operation of the UAV; and
determine whether the second sensing information satisfies a second contact condition, so as to determine an on/off status of the flight power module.

2. The landing and takeoff response system according to claim 1, wherein the first contact condition is a change in capacitance greater than a preset value or a detected distance less than a preset distance.

3. The landing and takeoff response system according to claim 1, wherein the second contact condition is a change in capacitance greater than a preset value or a detected distance less than a preset distance.

4. The landing and takeoff response system according to claim 1, wherein the first sensor and the at least one second sensor are one of a capacitance sensor, an image sensor, and a distance sensor, respectively.

5. The landing and takeoff response system according to claim 1, wherein the flight power module is in an off status in response to the second sensing information satisfying the second contact condition; the flight power module is in an on status in response to the second sensing information not satisfying the second contact condition.

6. The landing and takeoff response system according to claim 1, wherein the landing and takeoff operation of the UAV is prohibited in response to the first sensing information satisfying the first contact condition; the landing and takeoff operation of the UAV is permitted in response to the first sensing information not satisfying the first contact condition.

7. The landing and takeoff response system according to claim 6, wherein the landing and takeoff operation is to control a vertically upward or vertically downward flight of the UAV.

8. The landing and takeoff response system according to claim 1, wherein the flight power module is in an on status and provides a lift force less than a force sufficient for the UAV to take off vertically upward in response to the first sensing information satisfying the first contact condition and the second sensing information not satisfying the second contact condition.

9. The landing and takeoff response system according to claim 8, wherein the flight power module is capable of providing a hovering lift force sufficient for the UAV to maintain in a hovering mode in response to the first sensing information satisfying the first contact condition and the second sensing information not satisfying the second contact condition.

10. The landing and takeoff response system according to claim 1, wherein the flight power module is in an on status and capable of providing an ascent/descent force required for a vertically upward or vertically downward flight of the UAV within a predetermined altitude in response to the first sensing information and the second sensing information not satisfying the first contact condition and the second contact condition.

11. The landing and takeoff response system according to claim 10, wherein the UAV is restricted to move vertically upward or downward within the predetermined altitude.

12. A landing and takeoff response method for an unmanned aerial vehicle (UAV), the UAV comprising a fuselage having a housing and a flight power module connected to the fuselage, the landing and takeoff response method comprising:
detecting a first sensing information by a first sensor disposed on a bottom portion of the housing at a position below a center of gravity of the UAV;
detecting a second sensing information by at least one second sensor disposed on a side portion of the housing, the side portion adjacent to the bottom portion;
determining whether the first sensing information satisfies a first contact condition, so as to determine a landing and takeoff operation of the UAV; and
determining whether the second sensing information satisfies a second contact condition, so as to determine an on/off status of the flight power module.

13. The landing and takeoff response method according to claim 12, wherein the first contact condition is a change in capacitance greater than a preset value or a detected distance less than a preset distance.

14. The landing and takeoff response method according to claim 12, wherein the second contact condition is a change in capacitance greater than a preset value or a detected distance less than a preset distance.

15. The landing and takeoff response method according to claim 12, wherein the flight power module is in an off status in response to the second sensing information satisfying the second contact condition; the flight power module is in an on status in response to the second sensing information not satisfying the second contact condition.

16. The landing and takeoff response method according to claim 12, wherein the landing and takeoff operation of the UAV is prohibited in response to the first sensing information satisfying the first contact condition; the landing and takeoff operation of the UAV is permitted in response to the first sensing information not satisfying the first contact condition.

17. The landing and takeoff response method according to claim 16, wherein the landing and takeoff operation is to control a vertically upward or vertically downward flight of the UAV.

18. The landing and takeoff response method according to claim 12, wherein the flight power module is in an on status and provides a lift force less than a force sufficient for the UAV to take off vertically upward in response to the first sensing information satisfying the first contact condition and the second sensing information not satisfying the second contact condition.

19. The landing and takeoff response method according to claim 18, wherein the flight power module is capable of providing a hovering lift force sufficient for the UAV to maintain in a hovering mode in response to the first sensing information satisfying the first contact condition and the second sensing information not satisfying the second contact condition.

20. The landing and takeoff response method according to claim 12, wherein the flight power module is in an on status and capable of providing an ascent/descent force required for a vertically upward or vertically downward flight of the UAV within a predetermined altitude in response to the first sensing information and the second sensing information not satisfying the first contact condition and the second contact condition.
